(19) United States
(12) Patent Application Publication
(10) Pub. No.: US 2007/0183484 A1
(43) Pub. Date: Aug. 9, 2007

(54) SYSTEM AND METHOD OF FREQUENCY ACQUISITION

(76) Inventors: Matthias Brehler, Boulder, CO (US); Raghu Challa, San Diego, CA (US); Amit Mahajan, San Diego, CA (US); Emilija M. Simic, La Jolla, CA (US)

Correspondence Address: QUALCOMM INCORPORATED, 5775 MOREHOUSE DR., SAN DIEGO, CA, 92121, US

(21) Appl. No.: 11/552,900

(22) Filed: Oct. 25, 2006

Related U.S. Application Data
(60) Provisional application No. 60/731,562, filed on Oct. 27, 2005.

(51) Int. Cl. H04B 1/00; H04L 27/06

(52) U.S. Cl. 375/148; 375/344

(57) ABSTRACT

A system, method and device for frequency acquisition. In particular, the embodiments allow for a mobile telephone to simultaneously receive data and/or voice signals while acquiring a GPS signal for its navigation feature. The system, method and device of the present embodiments employ a digital rotator and a local oscillator in concert to acquire the respective signals, correct any frequency errors associated with those signals, and maintain a local timing reference suitable for receiving and transmitting data through a mobile network while simultaneously providing an accurate location through a GPS system.

### RELATED APPLICATIONS

This application claims the benefit of provisional U.S. Application Ser. No. 60/731,562, entitled “CODE DIVISION MULTIPLE ACCESS (CDMA) FREQUENCY ACQUISITION WITH SIMULTANEOUS GPS OPERATION,” filed Oct. 27, 2005, which is incorporated herein by reference in its entirety.

### FIELD OF THE PRESENT INVENTION

The present invention relates generally to communications, and more specifically to a novel and improved system and method for frequency acquisition for wireless communications with simultaneous GPS operation.

### BACKGROUND OF THE PRESENT INVENTION

Developments in mobile telephone technologies have led to the potential integration of telephony functions with navigation functions, referred to here generally as GPS capabilities. Parallel developments in the GPS and mobile telephones have led to a convergence of massive amounts of data and signals impinging upon a single receiver simultaneously. In particular, many mobile phones are developed with high data rate capabilities, rendering them useful for receiving electronic mail, browsing the World Wide Web, and other tasks that were previously relegated to personal computers having wired connections.

One aspect of mobile telephony is ensuring synchronization of the receiver with one or more base stations that are transmitting data, voice or multimedia signals to the receiver. Due to various transmission factors including multipath propagation, identical signals that are directed towards a receiver from the same base station will often arrive at different times, causing frequency errors and phase shifts of the signals and degrading the performance of the receiver. Typical mobile telephones employ a local oscillator to maintain a local timing reference signal to correct this frequency error and ensure optimum performance of the receiver. When starting the wireless communications service, the local oscillator much be adjusted to match the base station's reference frequency. This procedure is referred to as (frequency) acquisition and typically involves fast and large changes to the local oscillator.

GPS systems also require a stable local timing reference to ensure accurate navigation of a user with a receiver. The position of the receiver is determined at least in part by the timing of signals received from one or more satellites. If the local timing reference is not reliable, then the receiver's position will not be known relative to the satellites, and any navigation features of the receiver will be suspect. To ensure an accurate local timing reference, the receiver typically employs a local oscillator that is sufficiently stable to provide accurate location and navigation information to a user.

The combination of mobile telephony and GPS navigation into a single receiver therefore presents a problem as both systems depend upon a local oscillator to provide a local timing reference. However, during acquisition, the operation of the local oscillator is less stable due to large jumps in frequency correction. One prior solution to this problem is to have two local oscillators in each receiver, one for each of the GPS and telephony functions. This solution adds significant costs to the manufacture of a receiver and provides limited packaging options as each oscillator must have its own controls, temperature compensation, and insulation. Another solution to this problem is to not permit simultaneous operation of the receivers GPS and telephonic functions and to use a single local oscillator for only one function at a time. This solution is also undesirable, as it compartmentalizes the functions of any receiver, which in turn diminishes the value of that receiver to consumers.

What is needed therefore is an invention that provides a frequency acquisition system, method or receiver that enables a user to operate a mobile telephone and a GPS function simultaneously on a single receiver having a single local oscillator.

### SUMMARY OF THE PRESENT INVENTION

Accordingly, the present invention includes a receiver for frequency acquisition having a frequency control system that includes a digital rotator and a local oscillator. The digital rotator can correct frequency errors of a wireless signal thereby creating a timing signal allowing communication between the receiver and the base station. The frequency control system is adapted to operate one or both of the digital rotator and local oscillator to correct a frequency error associated with the wireless signal, in response to the magnitude of the frequency error.

The receiver described below further includes a controller in communication with the digital rotator and the local oscillator. The controller is adapted to receive a frequency error associated with the wireless signal and compare the frequency error with a first threshold value. The controller is further adapted to control the digital rotator to correct the frequency error in response to the frequency error being less than the first threshold. The controller is further adapted to control the local oscillator to correct the frequency error in response to the frequency error being greater than the first threshold value.

The present invention also includes a method of frequency acquisition including the steps of establishing a frequency of a local oscillator in response to a recent good system (RGS) value, receiving a wireless signal, and calculating a frequency error associated with the wireless signal. The method described below further includes the steps of comparing the frequency error with a first threshold value, correcting the frequency error utilizing a digital rotator in response to the frequency error being less than the first threshold value, and correcting the frequency error utilizing the local oscillator in response to the frequency error being greater than the first threshold value.

The present invention further includes a system for frequency acquisition. The system includes a digital rotator adapted to acquire a frequency error associated with a wireless signal. The digital rotator is adapted to correct the frequency error in response to the frequency error being less than a first threshold value. The system of the preferred embodiment also includes a local oscillator connected to the digital rotator. The local oscillator is adapted to correct the frequency error in response to the frequency error being greater than the first threshold value.

Further features and advantages of the present invention are described in detail below in terms of its preferred embodiments and modes of operation with reference to the following Figures.

### BRIEF DESCRIPTION OF THE DRAWINGS

FIG. 1 is a schematic diagram of a system for synchronous wireless signal and GPS signal frequency acquisition in accordance with a preferred embodiment of the present invention.

FIG. 2 is a schematic diagram of a device for frequency acquisition in accordance with a preferred embodiment of the present invention.

FIG. 3 is a flow chart depicting a method for frequency acquisition in accordance with the preferred embodiments of the present invention.

FIG. 4 is a schematic diagram of a typical prior art time tracking loop (TTL). Modifying the gain and the slew rate limit in FIG. 4 gives us a TTL that is adapted for frequency acquisition in a variation of the preferred embodiment of the present invention.

FIG. 5 is a graph modeling the time tracking behavior of a typical prior art TTL.

FIG. 6 is a schematic diagram of a time-tracking loop (TTL) adapted for frequency acquisition in a second variation of the preferred embodiment of the present invention.

FIG. 7 is a graph modeling the time tracking behavior of the TTL shown in FIG. 6.

### DETAILED DESCRIPTION OF THE PREFERRED EMBODIMENTS

The present invention is described below in terms of its preferred embodiments with reference to the aforementioned Figures. Those skilled in the art will recognize that the following detailed description is exemplary in nature, and that the scope of the present invention is defined by the appended claims.

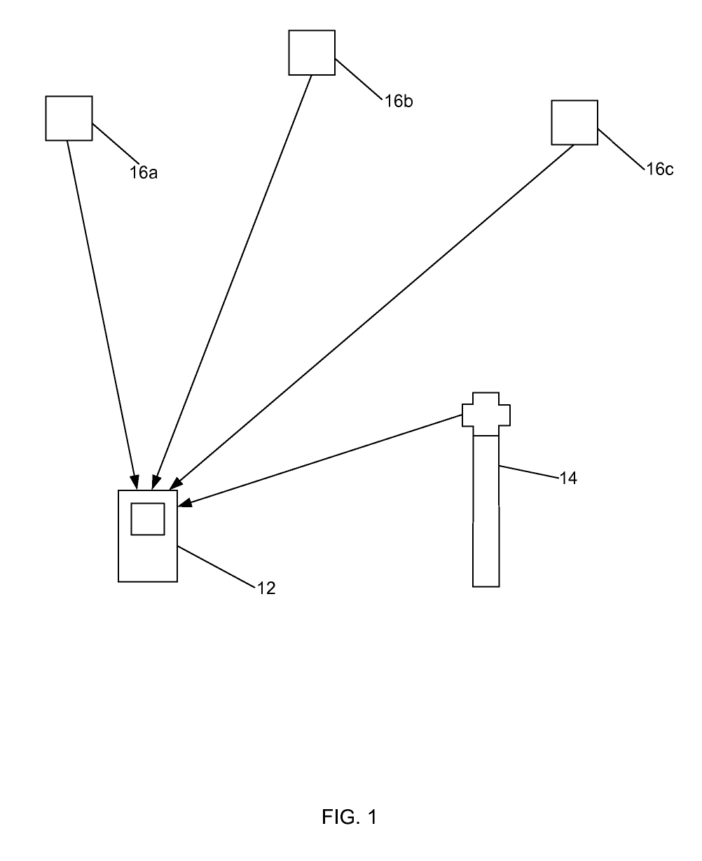

FIG. 1 is a schematic diagram of system 10 for synchronous or substantially synchronous wireless signal and GPS signal frequency acquisition. As shown, this embodiment includes receiver 12 for frequency acquisition. Receiver 12 of the preferred embodiment is in communication with a wireless communications base station 14 and a plurality of space vehicles (SVs) 16a, 16b and 16c. Receiver 12 can include for example a mobile telephone that is configured for sending and receiving voice or data transmissions, and also adapted to receive signals from plurality of SVs 16a, 16b and 16c for determining a position of receiver 12 through a Global Positioning System (GPS).

The GPS system can include one or more of the NAVSTAR Global Positioning System, the GLONASS GPS maintained by the Russian Republic, or the GALILEO system proposed in Europe. The NAVSTAR system includes a plurality of SVs 16a, 16b and 16c that transmit navigation messages at a data rate of fifty (50) bits per second by a direct sequence spread spectrum (DSSS) signals that is BPSK (binary phase-skift-keying) modulated onto a carrier signal at 1.57542 GHz, known as the L1 frequency. To spread the signal, each SV 16a, 16b and 16c uses a different one or a set of pseudo-random noise (PN) codes (also called coarse acquisition or C/A codes) that have a chip rate of 1.023 MHz and a length of 1023 chips. Plurality of SVs 16a, 16b and 16c can also transmit messages via a 10.23 MHz code modulated onto a carrier signal at 1.22760 GHz, called the L2 frequency. Signals received by receiver 12 are used to calculate a position in two or three dimensions. Typically, signals from at least four SVs are required to resolve a position in three dimensions, and signals from at least three SVs are required to resolve a position in two dimensions.

Receiver 12 can be configured for operation on one of a plurality of wireless systems. Wireless systems can be based on code division multiple access (CDMA), time division multiple access (TDMA), or some other modulation techniques. A CDMA system provides certain advantages over other types of systems, including increased system capacity. Alternatively, receiver 12 can be configured for operation on non-CDMA systems including for example the AMPS and GSM systems.

A CDMA system can be designed to support one or more CDMA standards such as those promulgated by TIA, EIA, 3GPP, 3GPP2, CWTS (China), ARIB (Japan), TTC (Japan), TTA (Republic of Korea), ITU and/or ETSI (Europe), CDMA, TD-SCDMA, W-CDMA, UMTS, IS-95-A/B/C (cdmaOne), IS-98, IS-835-A (cdma2000), IS-856 (cdma2000 HDR), IS-2000.1-A and other documents of the IS-2000 series, IS-707-A, cdma2000 1xEV, cdma2000 1xEV-DO, cdma2000 1xEV-DV, cdma2000 3x, 3GPP2 cdma2000, and IMT-2000. Receiver 12 can be adapted for communication over bands at or near 800 MHz, 1800 MHz, and /or 1900 MHz. Receiver 12 can be further adapted to communicate through different modes of M-ary phase-shift keying, including at least binary PSK (BPSK), quadrature PSK (QPSK), offset QPSK (OQPSK), quadrature amplitude modulation (QAM), minimum shift keying (MSK), or Gaussian MSK (GMSK). In another variation, receiver 12 can be configured to receive a DVB-H (Digital Video Broadcast-Handheld) signal or a DAB/DMB (Digital Audio/Multimedia Broadcast) or a MediaFLO (Forward Link Only) signal.

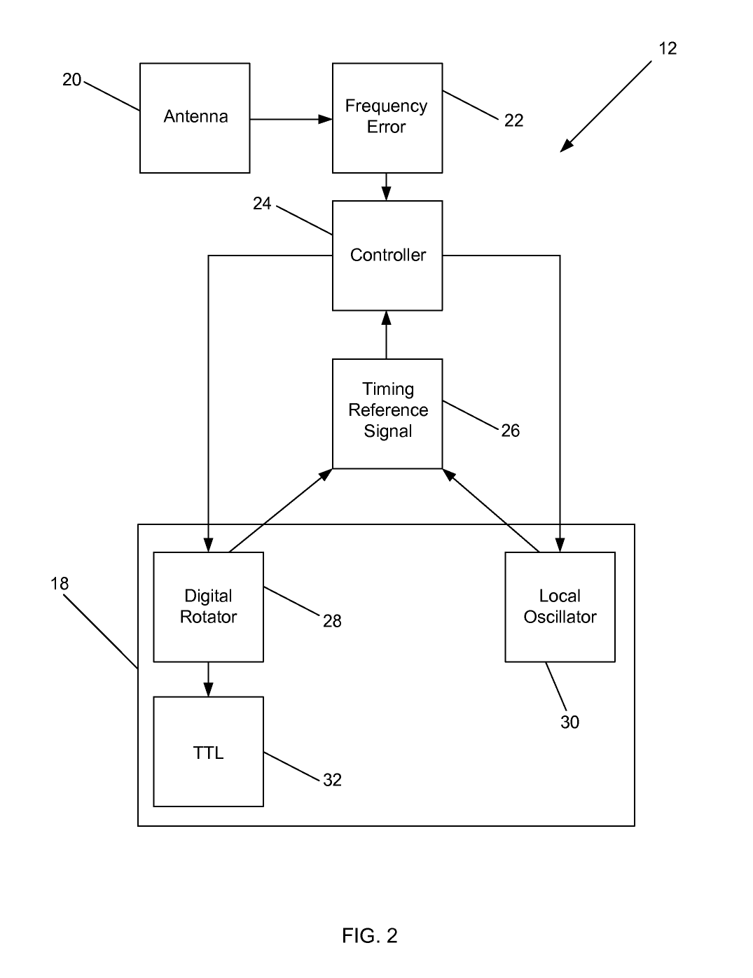

As shown in FIG. 2, receiver 12 of the preferred embodiment includes an antenna 20 adapted to receive a wireless signal, which may be formatted according to any of the standards noted above. Antenna 20 is further adapted to receive a GPS signal. As noted above, the term GPS signal includes any signal received from one or more of the NAVSTAR Global Positioning System, the GLONASS GPS maintained by the Russian Republic, or the GALILEO system proposed in Europe.

Receiver 12 of the preferred embodiment includes a frequency control system 18 including a digital rotator 28 and a local oscillator 30. Digital rotator 28 functions to correct frequency errors of a wireless signal thereby creating a timing signal 26 allowing communication between receiver 12 and base station 14. An exemplary digital rotator 28 is described in U.S. patent application Ser. No. 11/430,613, which is incorporated herein by reference in its entirety. Local oscillator 30 functions to maintain a timing signal 26 in substantial synchronization with a received wireless signal, thus permitting the functionality of both wireless communications and GPS systems. A suitable local oscillator 30 can include an inductive oscillator (LC oscillator), a crystal oscillator (XO), a surface-acoustic-wave (SAW) device, a voltage controlled crystal oscillator (VCXO), or a voltage controlled temperature compensated crystal oscillator (VCTCXO). Frequency control system 18 is adapted to operate one or both of digital rotator 28 and local oscillator 30 to correct a frequency error 22 associated with the wireless signal, in response to the magnitude of frequency error 22.

Receiver 12 of the preferred embodiment further includes a controller 24 in communication with digital rotator 28 and local oscillator 30. Controller 24 is adapted to receive a frequency error 22 associated with the wireless signal and compare frequency error 22 with a first threshold value. Controller 24 is further adapted to control digital rotator 28 to correct frequency error 22 in response to the frequency error 22 being less than the first threshold. Controller 24 is further adapted to control local oscillator 30 to correct frequency error 22 in response to the frequency error 22 being greater than the first threshold value.

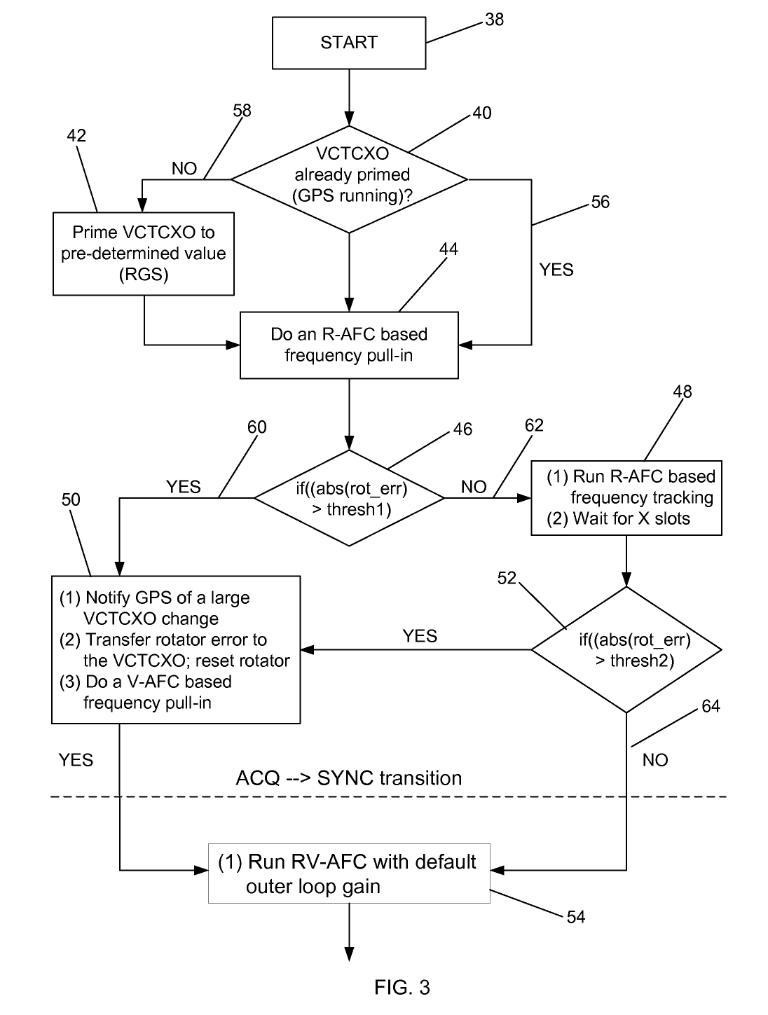

FIG. 3 is a flow chart showing the operation of the preferred embodiments of the present invention as described in conjunction with FIG. 2. In operation, controller 24 functions to maintain local oscillator 30 in a stable state while permitting the simultaneous receipt of GPS signals. During acquisition, the frequency error 22 between local oscillator 30 and base station 14 may be large (caused for example by temperature variations in the phone or Doppler shift), which would normally cause a large jump in local oscillator 30 in the state of the art. Any large jump in local oscillator 30 during GPS operation would substantially impair the accuracy of the navigation features of the GPS system. Alter start 38 as such, controller 24 of the preferred embodiment decides whether seeding the local oscillator is necessary for the acquisition 40: If GPS is already running (and thus the oscillator is already primed) it can proceed 56. If not 58, the controller sets local oscillator's 30 frequency to a predetermined value, the recent good system (RGS) value 42. The RGS value is a seeding value for the local oscillator typically obtained from a previous systems' AFC operation. In any case, controller 24 is further adapted to utilize digital rotator 28 to correct the remaining frequency error 22 by a rotator based frequency pull in 44. Provided that frequency error 22 is less than the first threshold, the frequency acquisition is completed 46. The first threshold is a predetermined value selected such that local oscillator 30 will be rarely, if ever, diverted from its oscillation value set by the GPS system. As noted above, in instances in which frequency error 22 is greater than the first threshold value 60, controller 24 will control local oscillator 30 to correct frequency error 22 relative to base station 14 by notifying the GPS of the large VCTCXO change, transferring the rotator error to the VCTCXO and resetting the rotator and performing a V-AFC based frequency pull-in 50. If the frequency error is less than the first threshold value 62. The R-AFC based frequency tracking is run and the system waits for X slots 48.

In a first variation of the preferred embodiment, controller 24 is further adapted to compare frequency error 22 with a second threshold value 52 and control local oscillator 32 to correct frequency error 22 in response to the frequency error 22 being greater than the second threshold value 64. The first threshold value can include, for example a frequency tolerance and an acquisition error, while the second threshold value can include a frequency tolerance. As such, in typical circumstances, the second threshold will be less than the first threshold.

In a second variation of the preferred embodiment, controller 24 is adapted to notify the GPS system of a frequency change associated with local oscillator 30. In operation, if frequency error 22 is larger than the first threshold value 60, then controller 24 will control local oscillator 30 to correct frequency error 22. As previously noted, a large jump in local oscillator's 30 frequency can cause substantial errors in the navigation measurements of the GPS system. Accordingly, controller 24 is adapted to notify the GPS system 50 such that local oscillator 24 can be controlled with minimal impact on the navigation features of receiver 12.

In a first alternative of the second variation of the preferred embodiment, controller 24 is adapted to suspend a GPS system search substantially simultaneous with the correction of the frequency error 22 by local oscillator 30. Alternatively, controller 24 can be adapted to suspend correction of the frequency error 22 by local oscillator 30 substantially simultaneously with a search by the GPS system. In each of these alternatives, frequency error 22 exceeds the first threshold value, and therefore controller 24 is adapted to take mitigating steps 50 to minimize the impact of local oscillator's 30 frequency changes on the performance of receiver 12.

In a third variation of the preferred embodiment, controller 24 is adapted to control digital rotator 28 and local oscillator 30 to correct frequency error 22 in response to the frequency error 22 being less than the second threshold 64. In this instance, frequency error 22 is sufficiently low that engagement of local oscillator 30 will likely not cause errors in the navigation features of receiver 12. As such, controller 24 can divide frequency error 22 into a digital rotator portion and a local oscillator portion, with each portion being corrected by its respective component of the frequency control system 54. Alternatively, controller 24 can be adapted to use digital rotator 28 or local oscillator 30 to correct frequency error 22.

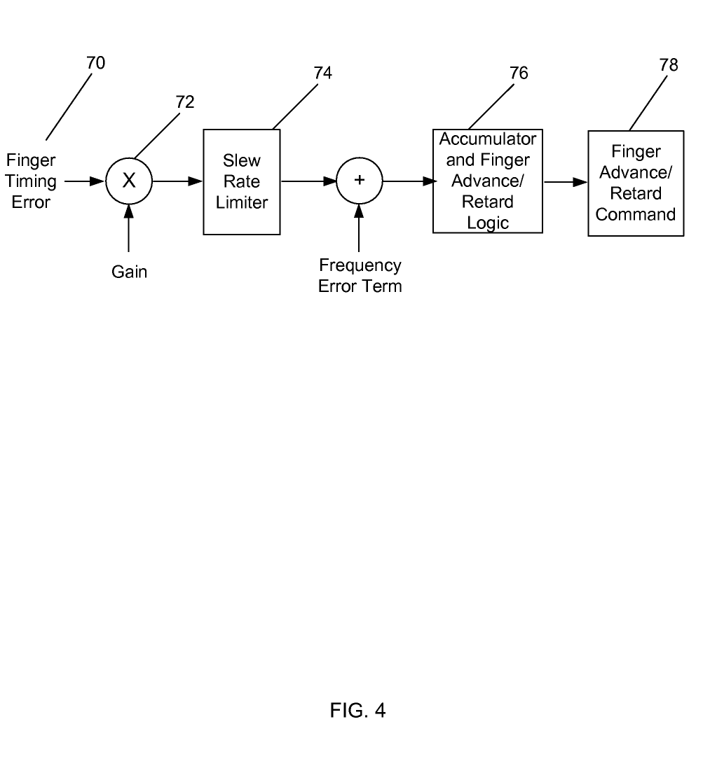

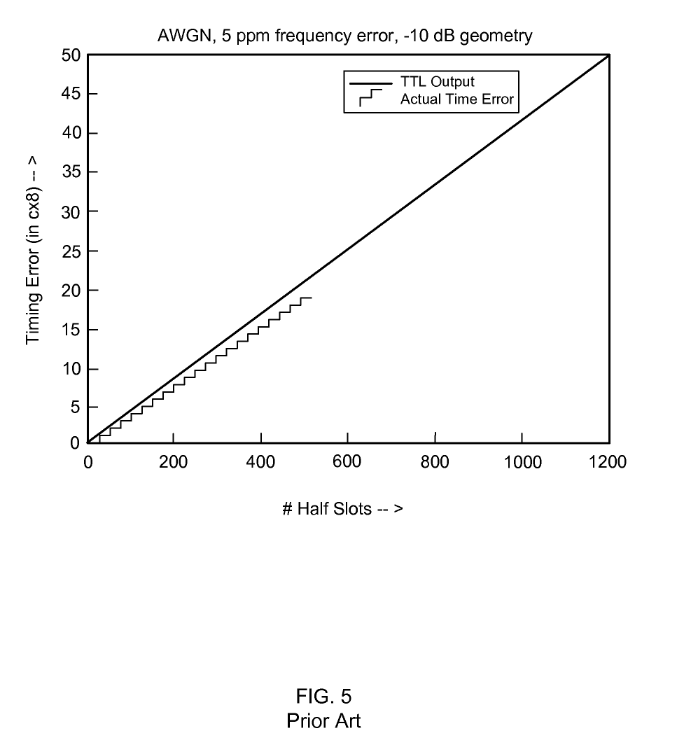

In a fourth variation of the preferred embodiment, controller 24 is adapted to calculate a finger timing error associated with digital rotator 28. In this instance, an error in the frequency of local oscillator 30 can affect the performance of receiver 12 during its acquisition phase of the wireless signal. In particular, if the error in local oscillator 30 is greater than a predetermined value, conventional means for correcting the finger timing error will prove insufficient, i.e., a conventional time tracking loop 32 (TTL), which is shown in FIG. 4, has a maximum adjustment rate that is insufficient to correct for drift in finger timing caused by large errors in local oscillator 30. For Example, FIG. 5 shows the output of a typical prior art legacy TTL when a 5 ppm step frequency error input is applied. In this figure, the actual timing error and the legacy TTL output are plotted as a function of the half slot number. As can be seen, the legacy TTL output lags the actual time error. Also, there is no legacy TTL output beyond approximately 500 half slots since the phone fails acquisition at this point because the TTL is unable to correct for a majority of the time error.

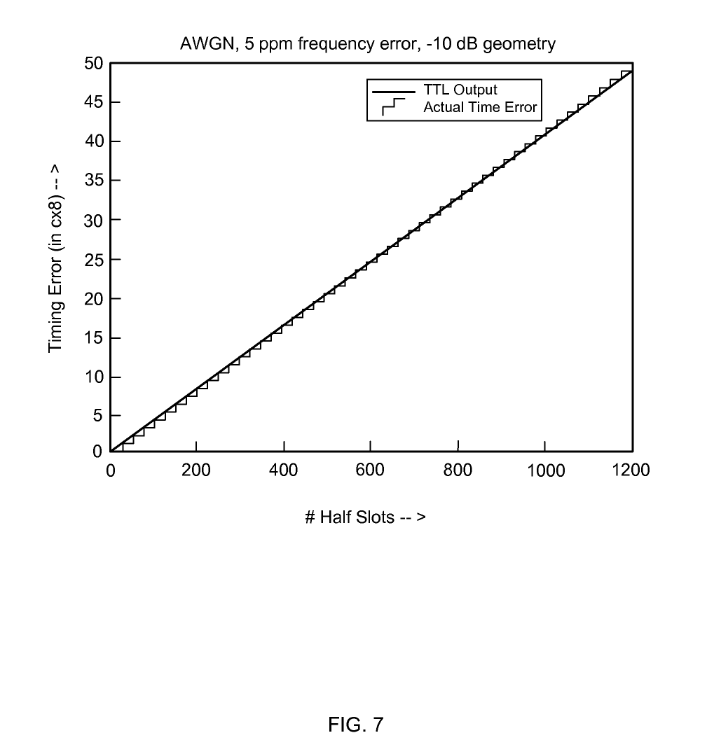

As such, in one alternative to the fourth variation of the preferred embodiment, receiver 12 includes a TTL 32 that is similar to the conventional TTL 32 of FIG. 4 but uses a different gain and slew rate limit. The values of the gain and the slew rate of TTL 32 are selected so as to provide TTL 32 with ample speed to adequately track the finger timing drift. This modified TTL 32 helps correct the timing error associated with digital rotator 28. FIG. 7 is a graphical model of the tracking capabilities of this modified TTL 32. As shown in FIG. 7, this modified TTL 32 is very adept at tracking finger-timing errors across a large range of half slots at a frequency error of five parts per million (ppm).

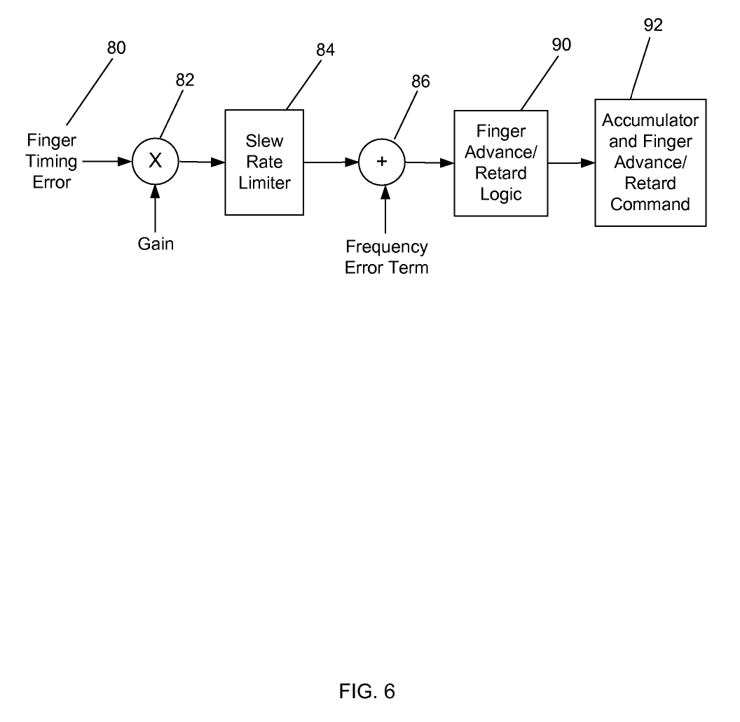

Alternatively, as shown in FIG. 6 TTL 32 can be adapted to correct the timing error in response to a drift rate proportional to the frequency error. In this example, frequency error 22 is utilized to calculate a finger timing drift rate, which is then fed forward into TTL 32 such that it is always fast enough to track the fingers irrespective of the magnitude of the error in local oscillator 30. FIG. 7 is a graphical model of the tracking capabilities of TTL 32 shown in FIG. 6. As shown in FIG. 7, TTL 32 of FIG. 6 is very adept at tracking finger-timing errors across a large range of half slots at a frequency error of five parts per million (ppm).

The present invention also includes a method of frequency acquisition. As shown in FIG. 3, the method of the preferred embodiment includes the steps of establishing a frequency of a local oscillator in response to a recent good system (RGS) value, receiving a wireless signal, and calculating a frequency error associated with the wireless signal. The method of the preferred embodiment further includes the steps of comparing the frequency error with a first threshold value, correcting the frequency error utilizing a digital rotator in response to the frequency error being less than the first threshold value, and correcting the frequency error utilizing the local oscillator in response to the frequency error being greater than the first threshold value.

The digital rotator functions to correct frequency errors of a wireless signal thereby creating a timing signal allowing communication between a receiver and a base station. An exemplary digital rotator is described in U.S. patent Application Ser. No. 11/430,613, which is incorporated herein by reference in its entirety. The local oscillator functions to maintain a timing signal in substantial synchronization with a received wireless signal, thus permitting the functionality of both wireless communications and GPS systems. A suitable local oscillator includes an inductive oscillator (LC oscillator), a crystal oscillator (XO), a surface-acoustic-wave (SAW) device, a voltage controlled crystal oscillator (VCXO), or a voltage controlled temperature compensated crystal oscillator (VCTCXO). The method of the preferred embodiment operates one or both of the digital rotator and local oscillator to correct a frequency error associated with the wireless signal, in response to the magnitude of the frequency error.

In a first variation of the preferred embodiment, the method further includes the step of comparing the frequency error with a second threshold value and correcting the frequency error utilizing the local oscillator in response to the frequency error being less than the second threshold value. The first threshold value can include, for example a frequency tolerance and an acquisition error, while the second threshold value can include a frequency tolerance. As such, in typical circumstances, the second threshold will be less than the first threshold.

In a second variation of the preferred embodiment, the method further includes the step of seeding the frequency of the local oscillator such that it is not excessively modified during the acquisition of the wireless signal, the consequences of which are a substantial degradation in the navigation function of the GPS system. The value to seed the local oscillator comes from the RGS.

In a third variation of the preferred embodiment, the method includes the step of notifying the GPS system of a frequency change associated with the local oscillator related to the step of correcting the frequency error utilizing a local oscillator. According to the method, if the frequency error is larger than the first threshold value, then the local oscillator is used to correct the frequency error. As previously noted, a large jump in the local oscillator frequency can cause substantial errors in the navigation measurements of the GPS system. Accordingly, the method includes the step of notifying the GPS system such that the local oscillator can be controlled with minimal impact on the navigation function of the GPS system.

Alternatively, the method can include the step of suspending a GPS system search substantially simultaneous with the correction of the frequency error by the local oscillator. Alternatively, the method can include the step of suspending the correction of the frequency error by the local oscillator substantially simultaneously with a search by the GPS system. In each of these alternatives, the frequency error exceeds the first threshold value, and therefore the method performs mitigating steps to minimize the impact of local oscillator frequency changes on the performance of the GPS system.

In a fourth variation of the preferred embodiment, the method recites the step of correcting the frequency error utilizing one of the digital rotator or the local oscillator in response to the frequency error being less than the second threshold. In this instance, the frequency error is sufficiently low that engagement of the local oscillator will likely not cause errors in the navigation features of the GPS system. As such, in an alternative to the third variation, the method recites the step of dividing the frequency error into a digital rotator portion and a local oscillator portion, with each portion being corrected by its respective component of the frequency control system. Alternatively, the method can further include the step of correcting the frequency error utilizing one or both of the digital rotator and the local oscillator in response to the frequency error being less than the second threshold.

In a fifth variation of the preferred embodiment, the method includes the step of calculating a finger timing error associated with the digital rotator. In this variation, an error in the frequency of the local oscillator can affect the acquisition of the wireless signal. In particular, if the error in the local oscillator is greater than a predetermined value, conventional means for correcting the finger timing error will prove insufficient, i.e., a conventional time tracking loop (TTL) has a maximum adjustment rate that is insufficient to correct for drift in finger timing caused by large errors in the local oscillator.

As such, in one alternative to the fifth variation of the preferred embodiment, the method recites the step of correcting the timing error utilizing a TTL with a predetermined gain and a predetermined slew rate. The values of the gain and the slew rate of the TTL are selected so as to provide the TTL with ample speed to adequately track the finger timing drift. As noted above, the TTL shown in FIG. 4, with the predetermined gain and slew rate limit, functions to correct the timing error associated with the digital rotator. In another alternative, the TTL can be adapted to correct the timing error in response to a drift rate proportional to the frequency error. In this example, the frequency error is utilized to calculate a finger timing drift rate, which is then fed forward into the TTL such that it is always fast enough to track the fingers irrespective of the magnitude of the error in the local oscillator.

The present invention also includes a system 18 for frequency acquisition. Referring again to FIG. 2, the system includes a digital rotator 28 adapted to acquire a frequency error associated with a wireless signal, the digital rotator adapted to correct the frequency error in response to the frequency error being less than a first threshold value. System 18 of the preferred embodiment also includes a local oscillator 30 connected to digital rotator 28. Local oscillator 30 is adapted to correct the frequency error in response to the frequency error being greater than the first threshold value. Digital rotator 28 and local oscillator 30 are connectable through a variety of means, including through a controller 24 of the type described above and shown in FIG. 2.

Digital rotator 28 functions to correct frequency errors of a wireless signal thereby creating a timing signal allowing communication between a receiver and a base station as shown in FIG. 1. An exemplary digital rotator 28 is described in U.S. patent application Ser. No. 11/430,613, which is incorporated herein by reference in its entirety. Local oscillator 30 functions to maintain a timing signal 26 in substantial synchronization with a received wireless signal, thus permitting the functionality of both wireless communications and GPS systems. A suitable local oscillator 30 includes an inductive oscillator (LC oscillator), a crystal oscillator (XO), a surface-acoustic-wave (SAW) device, a voltage controlled crystal oscillator (VCXO), or a voltage controlled temperature compensated crystal oscillator (VCTCXO). System 18 is adapted to operate one or both of digital rotator 28 and local oscillator 30 to correct a frequency error associated with the wireless signal, in response to the magnitude of the frequency error.

In a first variation of the preferred embodiment, system 18 further includes means for comparing the frequency error to the first threshold. Suitable means for comparing are detailed above with reference to a controller 24 that can be integrated into a receiver 12 of the type described above. Controller 24 can include one or more hardware or software components, including integrated circuitry including digital or analog operations, as well as any suitable memory, processing capacity and electronic communications circuitry necessary for comparing the frequency error to the first threshold. In one alternative to the first variation of the preferred embodiment, the means for comparing includes means for comparing the frequency error to a second threshold, the second threshold being less than the first threshold. As noted above, the first threshold value can include, for example a frequency tolerance of a predetermined value and an acquisition error within a predetermined range, while the second threshold value can include a frequency tolerance of a predetermined value. As such, in typical circumstances, the second threshold will be less than the first threshold.

In one alternative to the first variation of the preferred embodiment, digital rotator 28 and local oscillator 30 are adapted to cooperatively correct the frequency error in response to the frequency error being less then the second threshold. As such, system 18 can employ one or both of digital rotator 28 and local oscillator 30 to correct the frequency error. The utilization of digital rotator 28 and local oscillator 30 can further depend for example upon the magnitude of the frequency error and the status of any GPS system searches.

In a second variation of the preferred embodiment, system 18 includes a TTL 32 connected to digital rotator 28. TTL 32 is adapted to correct a finger timing error 70 of a predetermined value associated with digital rotator 28. In one alternative, TTL 32 is configured with a predetermined gain 72 and a predetermined slew rate limit 74 as shown in FIG. 4. The output of the slew rate limiter 74 is fed to the accumulator and the finger advance/retard logic block 76. This block computes the error in the finger position and issues an advance/retard command to the finger 78. The values of the gain 72 and the slew rate 74 of TTL 32 are selected so as to provide TTL 32 with ample speed to adequately track the finger timing drift. TTL 32 shown in FIG. 4 is adapted to correct timing error 70 associated with digital rotator 28. Alternatively, as shown in FIG. 6 TTL 32 can be adapted to correct finger timing error 80 in response to a drift rate proportional to the frequency error. TTL is configured with a predetermined gain 82 and a slew rate limit 84. In addition, the frequency error 86 is utilized to calculate a finger timing drift rate. This is then fed to the accumulator and the finger advance/retard logic block 90. This block computes the error in the finger position and issues an advance/retard command to the finger 92. This TTL 32 is fast enough to track the fingers irrespective of the magnitude of the error in local oscillator 30. Graphical models of the tracking abilities of the TTL embodiments shown in FIGS. 4 and 6 and described herein are provided in FIG. 7.

In a third variation of the preferred embodiment, local oscillator 30 is adapted to suspend a correction of the frequency error substantially simultaneous with a GPS system search. As used herein, the term GPS system search includes any signal received from a GPS system of the type described above. As noted above, any instance in which a large or unexpected change in the frequency of local oscillator 30 can be detrimental to the performance of a GPS system. Accordingly, local oscillator 30 of system 18 is adapted to maintain a predetermined value, such as for example the RGS value noted above, during a GPS system search to ensure the accuracy of the GPS system.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above, are hereby incorporated by reference.

We claim:

1. A method of frequency acquisition comprising:
establishing a frequency of a local oscillator in response to a recent good system (RGS) value;
receiving a wireless signal;
calculating a frequency error associated with the wireless signal;
comparing the frequency error with a first threshold value;
correcting the frequency error utilizing a digital rotator in response to the frequency error being less than the first threshold value; and
correcting the frequency error utilizing the local oscillator in response to the frequency error being greater than the first threshold value.

2. The method of claim 1 further comprising the step of comparing the frequency error with a second threshold value and correcting the frequency error utilizing the local oscillator in response to the frequency error being greater than the second threshold value.

3. The method of claim 2 wherein the second threshold is less than the first threshold.

4. The method of claim 3 wherein the first threshold includes a frequency tolerance and an acquisition error.

5. The method of claim 3 wherein the second threshold includes a frequency tolerance.

6. The method of claim 1 further comprising the step of receiving a GPS signal.

7. The method of claim 1 further comprising the step of notifying a GPS system of a frequency change associated with the local oscillator related to the step of correcting the frequency error utilizing a local oscillator.

8. The method of claim 7 further comprising the step of suspending a GPS system search substantially simultaneous with the correction of the frequency error by the local oscillator.

9. The method of claim 7 further comprising the step of suspending correction of the frequency error by the local oscillator substantially simultaneously with a search by the GPS system.

10. The method of claim 2 further comprising the step of correcting the frequency error utilizing the digital rotator and the local oscillator in response to the frequency error being less than the second threshold.

11. The method of claim 10 further comprising the step of dividing the frequency error into a digital rotator portion and a local oscillator portion.

12. The method of claim 1 further comprising the step of calculating a finger timing error associated with the digital rotator.

13. The method of claim 12 further comprising the step of correcting the timing error utilizing a time tracking loop with a predetermined gain and a predetermined slew rate.

14. The method of claim 13 further comprising the step of correcting the timing error utilizing a time tracking loop with a drift rate proportional to the frequency error.

15. A receiver comprising:
an antenna adapted to receive a wireless signal;
a frequency control system comprising a digital rotator and a local oscillator, the frequency control system adapted to correct a frequency error associated with the wireless signal; and
a controller in communication with the digital rotator and the local oscillator, the controller adapted to receive a frequency error associated with the wireless signal and compare the frequency error with a first threshold value,
wherein the controller controls the digital rotator to correct the frequency error in response to the frequency error being less than the first threshold and the controller controls the local oscillator to correct the frequency error in response to the frequency error being greater than the first threshold value.

16. The receiver of claim 15 wherein the controller is further adapted to compare the frequency error with a second threshold value and control the local oscillator to correct the frequency error in response to the frequency error being greater than the second threshold value.

17. The receiver of claim 16 wherein the second threshold is less than the first threshold.

18. The receiver of claim 16 wherein the first threshold includes a frequency tolerance and an acquisition error.

19. The receiver of claim 16 wherein the second threshold includes a frequency tolerance.

20. The receiver of claim 15 wherein the antenna is further adapted to receive a GPS signal.

21. The receiver of claim 15 further wherein the controller is adapted to notify a GPS system of a frequency change associated with the local oscillator.

22. The receiver of claim 21 further wherein the controller is adapted to suspend a GPS system search substantially simultaneous with the correction of the frequency error by the local oscillator.

23. The receiver of claim 21 wherein the controller is adapted to suspend correction of the frequency error by the local oscillator substantially simultaneously with a search by the GPS system.

24. The receiver of claim 15 wherein the controller is adapted to control the digital rotator and the local oscillator to correct the frequency error in response to the frequency error being less than the second threshold.

25. The receiver of claim 24 wherein the controller is adapted to divide the frequency error into a digital rotator portion and a local oscillator portion.

26. The receiver of claim 15 wherein the controller is adapted to calculate a finger timing error associated with the digital rotator.

27. The receiver of claim 26 further comprising a time tracking loop with a predetermined gain and a predetermined slew rate, the time tracking loop adapted to correct the timing error associated with the digital rotator.

28. The receiver of claim 26 wherein the time tracking loop is adapted to correct the timing error in response to a drift rate proportional to the frequency error.

29. A data storage medium having machine-readable instructions describing the method of frequency control according to claim 1.

30. A system for frequency acquisition comprising:
a digital rotator adapted to correct the frequency error in response to the frequency error being less than a first threshold value; and
a local oscillator connected to the digital rotator, the local oscillator adapted to correct the frequency error in response to the frequency error being greater than the first threshold value.

31. The system of claim 30 further comprising means for comparing the frequency error to the first threshold.

32. The system of claim 31 wherein the means for comparing includes means for comparing the frequency error to a second threshold value, the second threshold value being less than the first threshold.

33. The system of claim 30 wherein the first threshold includes a frequency tolerance and an acquisition error.

34. The system of claim 33 wherein the frequency tolerance is a predetermined value.

35. The system of claim 33 wherein the acquisition error is within a predetermined range.

36. The system of claim 30 further comprising a time tracking loop that is adapted to correct a timing error of a predetermined value associated with the digital rotator.

37. The system of claim 30 further comprising a time tracking loop configured with a predetermined gain and a predetermined slew rate limit, the time tracking loop adapted to correct the timing error associated with the digital rotator.

38. The system of claim 37 wherein the time tracking loop is adapted to correct the timing error in response to a drift rate proportional to the frequency error.

39. The system of claim 30 wherein the local oscillator is adapted to suspend a correction of the frequency error substantially simultaneous with a GPS system search.

40. The system of claim 32 wherein the digital rotator and the local oscillator are adapted to cooperatively correct the frequency error in response to the frequency error being less than the second threshold.
